(19) United States
(12) Patent Application Publication
(10) Pub. No.: US 2024/0314398 A1
(43) Pub. Date: Sep. 19, 2024

(54) VIDEO PROCESSING METHOD AND APPARATUS, AND DEVICE AND STORAGE MEDIUM

(71) Applicant: Beijing Bytedance Network Technology Co., Ltd., Beijing (CN)

(72) Inventors: Min ZHU, Beijing (CN); Jing CHEN, Beijing (CN); Siqi TAN, Beijing (CN)

(21) Appl. No.: 18/264,899

(22) PCT Filed: Feb. 7, 2022
(86) PCT No.: PCT/CN2022/075331

§ 371 Date: Aug. 9, 2023

(30) Foreign Application Priority Data
Feb. 9, 2021 (CN) 202110178439.3

(51) Int. Cl. H04N 21/472; H04N 21/431; H04N 21/482

(52) U.S. Cl. CPC H04N 21/47217; H04N 21/431; H04N 21/4825

(57) ABSTRACT

Provided are a video processing method and apparatus, and a device and a storage medium. The method includes: firstly, in response to a trigger operation for a video collection entry, jumping to a play page of a preset first video in a corresponding video collection, wherein the video collection is a collection of a plurality of videos comprising the preset first video therein; and playing the preset first video in the play page.

### CROSS-REFERENCE TO RELATED APPLICATIONS

The present disclosure is based on and claims priority of Chinese application for invention No. 202110178439.3, filed on Feb. 9, 2021, the disclosure of which is hereby incorporated into this disclosure by reference in its entirety.

### TECHNICAL FIELD

The present disclosure relates to the field of data processing, in particular to a video processing method, an apparatus, a device, and a storage medium.

### BACKGROUND

A video collection refers to a collection of videos that comprises multiple videos. A video collection allows several videos of a certain category to be saved as one collection. Moreover, by playing back a video collection, the sequential playback of videos in the video collection can be achieved.

### SUMMARY

In a first aspect, the present disclosure provides a video processing method, comprising: in response to a trigger operation on a video collection entrance, switching to a playback page of a preset first video in a video collection corresponding to the video collection entrance; wherein, the video collection is a collection of multiple videos comprising the preset first video; playing back the preset first video in the playback page.

In an optional implementation, the method further comprises: displaying a collection list exhibition entrance to the (current) video collection in a video title area in the playback page; wherein, the video title area is used to display video content description information of the preset first video; in response to a trigger operation on the collection list exhibition entrance, displaying a half-screen in the playback page, and displaying a list of the video collection in the half-screen window. In an optional implementation, after playing back the preset first video in the playback page, the method further comprises: in response to a trigger operation on a collection list exhibition entrance in the playback page of the preset first video, displaying a list of a video collection to which the preset first video belongs in the playback page; in response to a trigger operation on any video in the list, switching from the preset first video to a video corresponding to the trigger operation.

In an optional implementation, the video collection entrance is set in a user's homepage; wherein, in response to a trigger operation on the video collection entrance, switching to a playback page of a preset first video in a video collection corresponding to the video collection entrance comprises: in response to a trigger operation on the video collection entrance displayed on the user's homepage, switching from the user's homepage to a playback page of a preset first video in a video collection corresponding to the video collection entrance.

In an optional implementation, the method further comprises: in response to a trigger operation on a video collection creation entrance, switching to a video collection creation page; receiving a video collection title and a selected video identification in the video collection creation page; in response to a trigger operation for a video collection creation, creating a first video collection based on the video collection title and the selected video identification.

In an optional implementation, after the step of in response to a trigger operation for a video collection creation, creating a first video collection based on the video collection title and the selected video identification, the method further comprises: in response to the completion of the creation of the first video collection, switching from the video collection creation page to a playback page of a preset second video in the first video collection; and displaying a list of the first video collection in the playback page, while playing back the preset second video in the playback page.

In an optional implementation, after displaying a list of the first video collection in the playback page, the method further comprises: adjusting the order of videos in the list of the first video collection in response to an order adjustment operation.

In an optional implementation, after displaying a list of the first video collection in the playback page, the method further comprises: in response to the deletion operation on any video in the list of the first video collection, deleting the video from the first video collection and the list of the first video collection.

In an optional implementation, the method further comprises: displaying a window comprising a list of video collections to which a target video is addible, in response to a trigger operation for adding the target video to a video collection; and adding the target video to a selected video collection, if a selection operation is received on any video collection of the video collections to which the target video is addible.

In an optional implementation, the window comprising a list of video collections to which the target video is addible also comprises a video collection creation entrance; after the step of in response to a trigger operation for adding a target video to a video collection, displaying collection lists to which the target video is addible, the method further comprises: if a trigger operation is received on the video collection creation entrance displayed in the window comprising a list of video collections to which the target video is addible, switching to a video collection creation page; creating a second video collection based on the target video in the video collection creation page.

In a second aspect, the present disclosure provides a video processing apparatus, comprising: a first switching module for, in response to a trigger operation on a video collection entrance, switching to a playback page of a preset first video in a video collection corresponding to the video collection entrance; wherein, the video collection is a collection of multiple videos comprising the preset first video; a playback module for playing back the preset first video in the playback page.

In a third aspect, the present disclosure provides a non-transitory computer-readable storage medium having instructions stored therein, wherein the instructions, when executed on a terminal device, cause the terminal device to implement the method described above.

In a fourth aspect, the present disclosure provides an electronic device, comprising: a processor, a memory, and the memory being stored with a computer program which is executable on the processor, wherein the processor, when executing the computer program, implements the method described above.

In a fifth aspect, the present disclosure provides a computer program product comprising a computer program/instructions that, when executed by a processor, implements the method described above. In a fifth aspect, the present disclosure provides a computer program, comprising:

instructions that, when executed by a processor, cause the processor to perform the video processing method of any one of the above embodiments.

### BRIEF DESCRIPTION OF THE DRAWINGS

Herein, the accompanying drawings, which are incorporated in and constitute a part of this specification, illustrate embodiments of the present disclosure and, together with the description, serve to explain the principles of the present disclosure.

In order to more clearly explain the embodiments of the present disclosure or the technical solutions in the related art, a brief introduction will be given below for the drawings required to be used in the description of the embodiments or the related art. It is obvious that, for a person skilled in the art, he or she may also acquire other drawings according to such drawings on the premise that no inventive effort is involved.

FIG. 1 is a flowchart of a video processing method provided in some embodiments of the present disclosure;

FIG. 2 is a schematic diagram showing the effect of switching to a playback page of a video collection provided in some embodiments of the present disclosure;

FIG. 3 is a flowchart of another video processing method provided in some embodiments of the present disclosure;

FIG. 4 is a schematic diagram showing the effect of a playback page with a collection list exhibition entrance provided in some embodiments of the present disclosure;

FIG. 5 is a schematic diagram showing the effect of a video collection list triggered to be displayed based on a collection list exhibition entrance provided in some embodiments of the present disclosure;

FIG. 6 is a flowchart of another video processing method provided in some embodiments of the present disclosure;

FIG. 7 is a flowchart of a video addition method provided in some embodiments of the present disclosure;

FIG. 8 is a schematic structural diagram of a video processing apparatus provided in some embodiments of the present disclosure;

FIG. 9 is a schematic structural diagram of a video processing apparatus provided in some embodiments of the present disclosure.

### DETAILED DESCRIPTION

In order to better understand the above objects, features and advantages of the present disclosure, the scheme of the present disclosure will be further described below. It should be noted that, in the case of no conflict, the embodiments and the features of the embodiments of the present disclosure may be combined with each other.

Many specific details are set forth in the following description to facilitate a full understanding of the present disclosure, but the present disclosure can also be implemented in other ways different from those described herein. Obviously, embodiments described in the description are only some embodiments of the present disclosure, and are not all of embodiments thereof.

Currently, the process of triggering playback of videos in a video collection is quite complicated, requiring users to go through multiple steps, which may affect user experience. Therefore, how to simplify the operation process of triggering the playback of videos in a video collection and improve the user experience is an urgent technical problem that needs to be solved.

In order to solve or at least partially solve the above technical problem, the present disclosure provides to a video processing method, an apparatus, an electronic device, and a storage medium that can simplify the operation of triggering the playback of videos in a video collection, and thus improve the user experience.

As mentioned above, a video collection refers to a collection of videos that comprises multiple videos. In video applications, a plurality of the first videos belonging to the same category are usually stored in the form of a video collection, such as a funny video collection.

In current video application software, the user's operation for triggering the playback of a video collection is complicated, which may affect the user experience. In view of this, the present disclosure provides a video processing method in which a user only needs to perform a single operation to trigger the playback of a video collection, wherein the operation of the present disclosure is simple and can improve the user experience.

For examples, the method of the present disclosure comprises, in response to a trigger operation on a video collection entrance: switching to a playback page of a preset first video in a video collection corresponding to the video collection entrance; and then playing back the preset first video in the playback page. Thus, this disclosure can achieve one-click triggering of playback of a video collection.

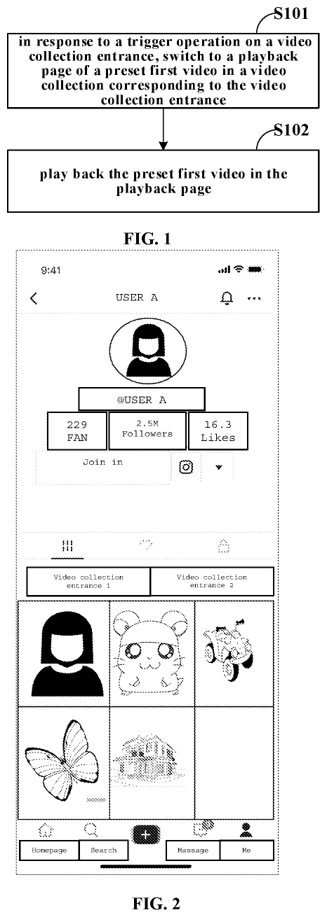

On this basis, embodiments of the present disclosure provide a video processing method. FIG. 1 is a flowchart of a video processing method provided in some embodiments of the present disclosure. As shown in the figure, the method comprises the following steps.

In S101, in response to a trigger operation on a video collection entrance, switch to a playback page of a preset first video in a video collection corresponding to the video collection entrance.

In some embodiments of the present disclosure, a video collection is a collection of multiple videos comprising the preset first video. A video collection entrance can be set up in a page of any type, such as a user's homepage. Alternatively, multiple video collection entrances can be set up in one user's homepage, with each video collection entrance corresponding to each video collection.

In some embodiments of the present disclosure, in response to receive a trigger operation on a video collection entrance, the current page can be directly switched to the playback page of a preset first video in the corresponding video collection, wherein the preset first video may be a priority video determined based on the playback sequence of the videos in the video collection.

In an optional implementation, video collection entrances may be in a user's homepage. A user may click on any one of these video collection entrances to trigger switching from the user's homepage to a playback page of a preset first video in a video collection corresponding to that video collection entrance, thereby achieving playback of videos in that video collection.

FIG. 2 is a schematic diagram showing the effect of switching from a user's homepage to a playback page of a preset first video in a video collection provided in some embodiments of the present disclosure. As shown in the figure, the homepage of user A comprises video collection entrance 1 corresponding to video collection 1 and video collection entrance 2 corresponding to video collection 2. After receiving the trigger operation, i.e., a click on video collection entrance 1, the current page is switched from the user's homepage to a playback page of a preset first video in video collection 1 corresponding to video collection entrance 1.

In S102, play back the preset first video in the playback page.

In the above embodiments of the present disclosure, a video processing method is provided, which comprises: first, in response to a trigger operation on a video collection entrance, switching to a playback page of a preset first video in a corresponding video collection, and then playing back the preset first video in the playback page. Thus, in some embodiments of the present disclosure, when a video collection entrance is triggered, a preset first video in a video collection is directly played back. That is, the playback of videos in the video collection can be triggered by a single operation of the user, which is simple and may improve the user experience.

In some embodiments of this disclosure, after switching to the playback page of a preset first video in a video collection, the preset first video in the video collection is automatically played back in the playback page. After the preset first video is complete, the playback of other videos in the video collection may be automatically triggered. For examples, other videos in the video collection can be automatically played back according to a playback sequence of the videos in the video collection. The playback sequence of the videos in the video collection may be a preset sequence.

In some embodiments of this disclosure, after the preset first video is complete, the playback of other videos in the video collection may be triggered. For examples, after a first video is complete, a next video of the first video is automatically played back based on the playback sequence of the videos in the video collection, until all the videos in the video collection are complete. In addition, when all the videos in the video collection are complete, the videos in the video collection can be played back contentiously in a playback sequence starting with the first video in the video collection.

In an optional implementation, after switching from a user's homepage to the playback page of a preset first video in a video collection, the preset first video in the video collection is played back in the playback page. For examples, each video in the video collection may be played back in a preset playback sequence.

In an optional implementation, the sequence in which each video is added to a video collection can be used as the preset playback sequence, and each video in the video collection can be played back sequentially according to the preset playback sequence.

In the video processing method provided in some embodiments of the present disclosure, in response to a trigger operation on a video collection entrance, the current page is first switched to a playback page of a preset first video in a corresponding video collection, and then the preset first video is played in the playback page. Thus, in some embodiments of the present disclosure, when a video collection entrance is triggered, a preset first video in a video collection is directly played. That is, the playback of videos in the video collection can be triggered by a single operation of the user, which is simple and may improve the user experience.

On the basis of the above embodiments, the present disclosure further provides a video processing method. FIG. 3 is a flowchart of another video processing method provided in some embodiments of the present disclosure. As shown in the figure, the method comprises the following steps.

In S301, in response to a trigger operation on a video collection entrance, switch to a playback page of a preset first video in a video collection corresponding to the video collection entrance.

In S302, play back the preset first video in the playback page.

S301 and S302 in some embodiments can be understood with reference to the descriptions of S101 and S102 of the above embodiments and will not be repeated here.

In S303, display a collection list exhibition entrance of the video collection in a video title area in the playback page. The video title area is used to display video content description information of the preset first video.

In embodiments of the present disclosure, a collection list exhibition entrance of a video collection is displayed in the playback page of a preset first video of the video collection. For examples, the collection list exhibition entrance is located in a video title area in the playback page.

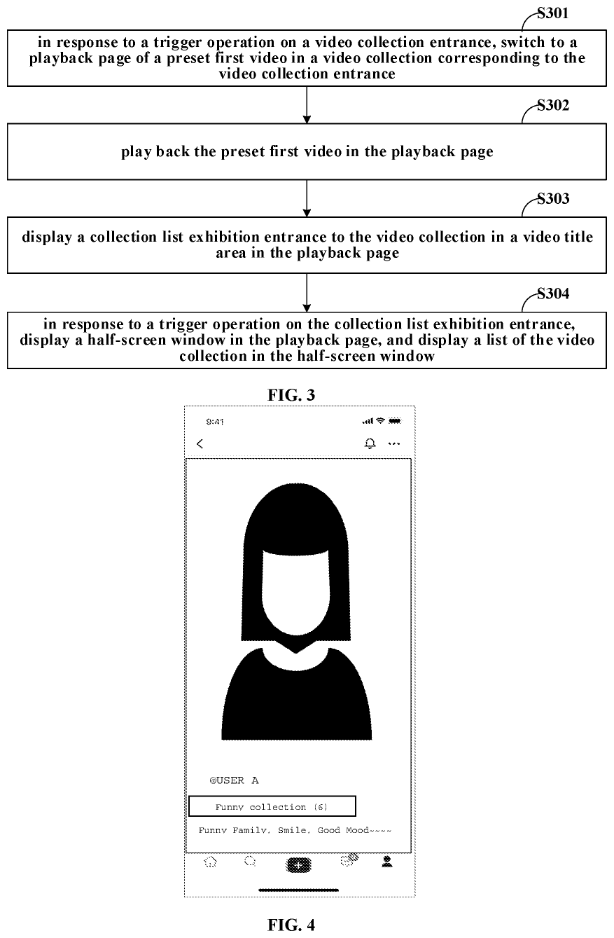

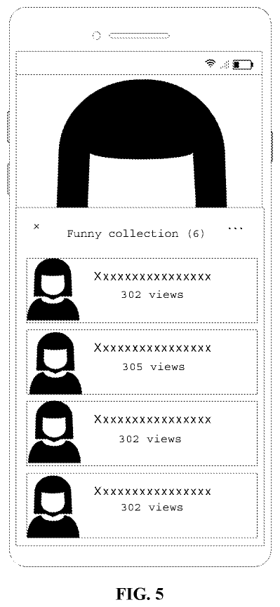

FIG. 4 is a schematic diagram showing the effect of a playback page with a collection list exhibition entrance provided in some embodiments of the present disclosure. The video content description information (comprising a video title, etc.) of the preset first video being played back in the playback page is displayed in the video title area, such as “Funny Family, Smile, Good Mood˜˜”, and a collection list exhibition entrance (such as “Funny Collection (6)” shown in FIG. 4) may be displayed above the description information “Funny Family, Smile, Good Mood˜”, which can be used to trigger a function of displaying a collection list of the video collection to which the video being played back belongs. The “Funny Collection (6)” in FIG. 4 is the collection list exhibition entrance.

In addition, the collection list exhibition entrance can also be displayed following the video content description information in the video title area or interspersed within the video content description information. The display position of the specific collection list exhibition entrance is not strictly limited in the embodiments of this disclosure.

The collection list exhibition entrance may be in the form of a button displaying the title of the video collection and the number of videos that are comprised in the video collection.

In S304, in response to a trigger operation on the collection list exhibition entrance, displaying a half-screen window in the playback page, and displaying a list of the video collection in the half-screen window.

In some embodiments of this disclosure, after receiving a trigger operation on a collection list exhibition entrance in a playback page, a half-screen window is displayed in the playback page to avoid interfering with the user's viewing of the video being played back in the playback page. In addition, the list of a video collection to which the video being played back belongs is displayed on the half-screen window, that is to say, the list of a video collection corresponding to the collection list exhibition entrance is displayed in the half-screen window. Users can select and play back other videos in the video collection through the displayed list of the video collection.

In an optional implementation, the trigger operation on the collection list exhibition entrance may be a long press on the collection list exhibition entrance, which is not specifically limited in the present disclosure.

FIG. 5 is a schematic diagram showing the effect of a video collection list triggered to be displayed based on a collection list exhibition entrance provided in some embodiments of the present disclosure.

The list of the video collection is displayed in a half-screen window in the playback page, and the half-screen window has a preset transparency that does not affect video playback when the list is displayed.

While the list of the video collection is displayed on the half-screen window, by clicking on any of the videos in the list, the user can switch the current video to the playback page of the clicked video.

In the video processing method provided in embodiments of the present disclosure, when a trigger operation on a video collection entrance is received, the current page is switched to a playback page of a corresponding video collection firstly, and then a preset first video in the video collection is played back in the playback page. Thus, in some embodiments of the present disclosure, when a video collection entrance is triggered, a preset first video in a video collection is directly played back. That is, the playback of videos in the video collection can be triggered by a single operation of the user, which is simple and may improve the user experience.

Furthermore, in some embodiments of this disclosure, a collection list exhibition entrance is displayed in the video title area in the playback page, which can guide the user to enter a window displaying of a collection list. By displaying the collection list exhibition entrance in the video title area, the information of the video collection is prompted based on the current video title content, allowing users to anticipate other video contents in the video collection, thereby improving the user experience.

On the basis of the above embodiments, embodiments of the present disclosure further provides a video processing method comprising: in response to a trigger operation on a collection list exhibition entrance in the playback page of the preset first video, displaying a list of a video collection to which the preset first video belongs in the playback page; in response to a trigger operation on any video in the list, switching from the preset first video to a video corresponding to the trigger operation.

In practical applications, when playing back the preset first video, if a trigger operation on a collection list exhibition entrance in the playback page of the preset first video (i.e., current video) is received, the list of a video collection to which the preset first video belongs is displayed in the playback page. If a trigger operation on any video in the list is received, the preset first video is switched to a video corresponding to the trigger operation to play back the video.

In an optional implementation, if a trigger operation on a collection list exhibition entrance is received in the playback page of the preset first video, the list of a video collection to which the preset first video belongs is displayed in the playback page of the preset first video. When a trigger operation is received on any video in the list of the video collection, the preset first video stream is switched to an information stream of the video collection, and a video corresponding to the trigger operation is played back based on the information stream.

In the process of playing back the video based on the information of the video collection, if the video is complete, a next video in the video collection will be played back automatically until all the videos in the video collection are complete. In addition, when all the videos in the video collection are complete, the videos in the video collection can be played back contentiously in a playback sequence starting with the first video in the video collection.

In some embodiments of the present disclosure, once the collection list exhibition entrance is triggered by the user, it indicates that the user is interested in the corresponding video collection. Therefore, the embodiments of this disclosure achieve sequential playback of each video in the video collection by switching to the information stream of the video collection, thereby improving the user experience.

On the basis of the above embodiments, the present disclosure further provides a video processing method that not only provides a video collection entrance for video viewers so that they can enter the video playback page by triggering the video collection entrance with a click, but also provides a video collection creation entrance for creating video collections.

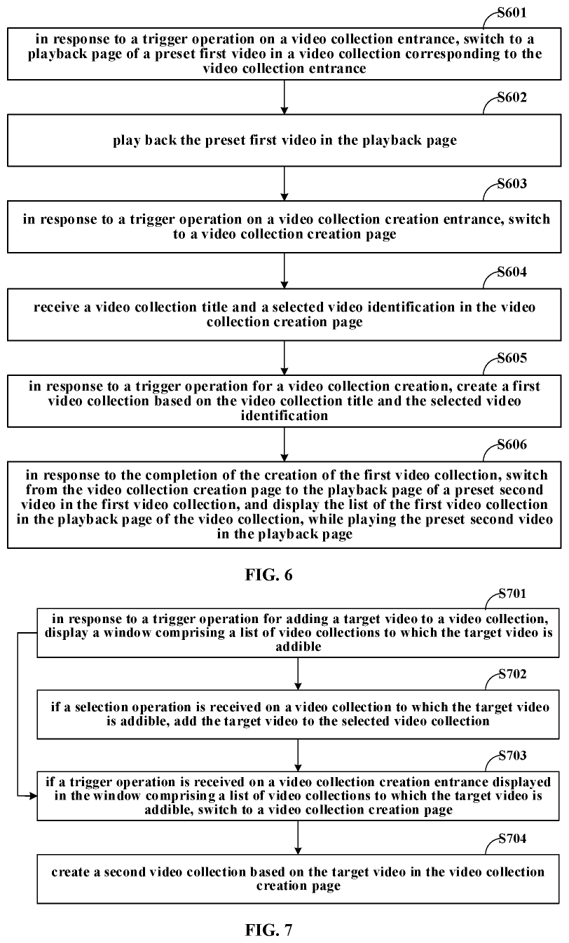

FIG. 6 is a flowchart of another video processing method provided in some embodiments of the present disclosure. The method comprises the following steps.

In S601, in response to a trigger operation on a video collection entrance, switch to a playback page of a preset first video in a video collection corresponding to the video collection entrance; the video collection is a collection of multiple videos comprising the preset first video.

In S602, play back the preset first video in the playback page.

S601 and S602 in some embodiments can be understood with reference to the descriptions of the above embodiments and will not be repeated here.

In S603, in response to a trigger operation on a video collection creation entrance, switch to a video collection creation page.

In some embodiments of this disclosure, a video collection creation entrance is deployed on a preset page. By triggering the video collection creation entrance, a video collection creation page can be accessed to create a video collection. The preset page may comprise a user's homepage, etc.

In an optional implementation, a video collection creation entrance can be provided in a user's homepage, and the user can trigger the video collection creation entrance to switch to the video collection creation page from the user's homepage.

In S604, receive a video collection title and a selected video identification in the video collection creation page.

In some embodiments of this disclosure, a user can enter a video collection title in the video collection creation page and select a video from the current user's videos to add it to the video collection. The selected video identification is the identification of the video selected from the current user's videos.

In S605, in response to a trigger operation for a video collection creation, creating a first video collection based on the video collection title and the selected video identification.

In some embodiments of this disclosure, after receiving a trigger operation for a video collection creation, a first video collection is created based on the entered video collection title and the selected video identification. According to embodiments of this disclosure, the first video collection can be published so that other users can watch the first video collection.

In practical applications, a video collection creation control can be provided in the video collection creation page. After the user clicks this control, it triggers the creation of a video collection.

In S606, in response to the completion of the creation of the first video collection, switch from the video collection creation page to the playback page of a preset second video in the first video collection and displaying the list of the first video collection in the playback page of the video collection, while playing the preset second video in the playback page.

In some embodiments of this disclosure, after completing the creation of the first video collection, the video collection creation page is automatically switched to the playback page of a preset second video in the first video collection. The preset second video in the video collection is played back in the playback page, while the list of the first video collection is displayed in the playback page.

In an optional implementation, when displaying the list of the first video collection in the playback page, the arrangement order of videos in the list of the first video collection can be adjusted according to an order adjustment operation. For example, the user can adjust the order of a video in the list by dragging it to a corresponding position. For another example, the user can trigger the adjustment of the order of the videos in the list by clicking a button to sort them by upload time.

In another optional implementation, when the list of the first video collection is displayed in the playback page, a video in the list of the first video collection can be deleted in response to a deletion operation. For examples, in response to receive a deletion operation on any video in the list of the first video collection, the video is deleted from the first video collection and the list.

In addition, on the basis of the above embodiments, embodiments of the present disclosure can also provide a video collection creation entrance for video creators, to create video collections and play back the created video collections. For examples, embodiments of this disclosures can at least comprise S603-S606 described above, and video creators are enabled to create video collections by performing steps S603-S606. In addition, the embodiments comprising the creation of video collections described above can be executed on the clients of video collection creators or on the clients of video viewers.

In some embodiments of this disclosure, through providing the function of creating video collections, the functionality of the application is expanded, and the user experience is improved.

On the basis of the above embodiments, the present disclosure further provides a method for adding videos based on an existing video collection. FIG. 7 is a flowchart of a video addition method provided in some embodiments of the present disclosure. As shown in the figure, the method comprises the following steps.

In S701, in response to a trigger operation for adding a target video to a video collection, display a window comprising a list of video collections to which the target video is addible.

The target video in embodiments of the present disclosure may be from personal video resources of a video collection creator. For examples, after selecting the target video, the video collection creator can trigger the function of adding a video to a video collection, and a window comprising collection lists to which the target video is addible is displayed.

In practical applications, users usually only have the permission to add videos to their own video collections. Therefore, in some embodiments of this disclosure, the list of video collections to which the target video is addible is the list of video collections of the current user.

In S702, if a selection operation is received on a video collection to which the target video is addible, adding the target video to the selected video collection.

In some embodiments of this disclosure, after selecting a video collection from the video collections to which the target video is addible, the user may trigger the addition of the target video to the selected video collection, resulting in an increase in the number of videos in the video collection.

In S703, if a trigger operation is received on a video collection creation entrance displayed in the window comprising a list of video collections to which the target video is addible, switch to a video collection creation page.

In some embodiments of this disclosure, after the user selects a target video, a new video collection can be created for the target video. For examples, when a trigger operation is received on a video collection creation entrance placed in the window comprising a list of video collections to which the target video is addible, the current page is switched to a video collection creation page.

S704: create a second video collection based on the target video in the video collection creation page.

In some embodiments of this disclosure, a second video collection is created in the video collection creation page, which comprises the target video. The creation process can be understood by referring to the above embodiments of a video collection creation, which will not be repeated here.

In the method of adding a new video to a video collection provided by the present embodiments of this disclosure, it is possible to add a new video based on existing video collections. Moreover, it is also possible to create a new video collection for the video. Thus, the functionality of the application is expanded, and the user experience is improved.

On the basis of the same inventive concept, the present disclosure further provides a video processing apparatus. FIG. 8 is a schematic structural diagram of a video processing apparatus provided in some embodiments of the present disclosure. As shown in the figure, the apparatus comprises the following modules.

A first switching module 801 is for, in response to a trigger operation on a video collection entrance, switching to a playback page of a preset first video in a video collection corresponding to the video collection entrance; a playback module 802 is for playing back the preset first video in the playback page.

In an optional implementation, the apparatus further comprises: a display module for displaying a collection list exhibition entrance to the (current) video collection in a video title area in the playback page; wherein, the video title area is used to display video content description information of the preset first video; a first exhibition module for in response to a trigger operation on the collection list exhibition entrance, displaying a half-screen window in the playback page, and displaying a list of the video collection in the half-screen window.

In an optional implementation, the apparatus further comprises: a second exhibition module for in response to a trigger operation on a collection list exhibition entrance in the playback page of the preset first video, displaying a list of a video collection to which the preset first video belongs in the playback page; a second switching module for in response to a trigger operation on any video in the list, switching from the preset first video to a video corresponding to the trigger operation.

In an optional implementation, the video collection entrance is set in a user's homepage; wherein, the first switching module is particularly used for: in response to a trigger operation on the video collection entrance in the user's homepage, switching from the user's homepage to a playback page of a preset first video in a corresponding video collection.

In an optional implementation, the apparatus further comprises: a third switching module for in response to a trigger operation on a video collection creation entrance, switching to a video collection creation page; a receiving module for receiving a video collection title and a selected video identification in the video collection creation page; a first creation module for in response to a trigger operation for a video collection creation, creating a first video collection based on the video collection title and the selected video identification.

The third switching module, the receiving module, and the first creation module mentioned above can be implemented independently of the video viewer side, to provide a video collection creation entrance for video creators.

In an optional implementation, the apparatus further comprises: a switching and exhibiting module for in response to the completion of the creation of the first video collection, switching from the video collection creation page to a playback page of a preset second video in the first video collection; and displaying a list of the first video collection in the playback page, while playing the preset second video in the playback page.

In an optional implementation, the apparatus further comprises: an order adjustment module for adjusting the order of videos in the list of the first video collection in response to an order adjustment operation.

In an optional implementation, the apparatus further comprises: a deletion module for in response to the deletion operation on any video in the list of the first video collection, deleting the video from the first video collection and the list.

In an optional implementation, the apparatus further comprises: a third exhibition module for in response to a trigger operation target video to a video collection, displaying a window comprising a list of video collections to which the target video is addible; an addition module for if a selection operation is received on any of the video collections to which the target video is addible, adding the target video to the selected video collection.

In an optional implementation, the window comprising a list of video collections to which the target video is addible also comprises a video collection creation entrance; the apparatus further comprises: a fourth switching module for if a trigger operation is received on the video collection creation entrance displayed in the window comprising a list of video collections to which the target video is addible, switching to a video collection creation page; a second creation module for creating a second video collection based on the target video in the video collection creation page.

In the video processing apparatus provided in some embodiments of the present disclosure, in response to a trigger operation on a video collection entrance, the current page is first switched to a playback page of a preset first video in a corresponding video collection, and then the preset first video is played in the playback page. Thus, In some embodiments of the present disclosure, when a video collection entrance is triggered, videos in a video collection is directly played. That is, the playback of videos in the video collection can be triggered by a single operation of the user, which is simple and may improve the user experience.

In addition to the above method and apparatus, the present disclosure further provides a non-transitory computer-readable storage medium stored thereon instructions that, when executed on a terminal device, cause the terminal device to implement the video processing method of the present disclosure.

Embodiments of the present application also provides a computer program product containing a computer program/instructions, characterized in that the computer program/instructions, when executed by a processor, implement the video processing method of the present disclosure.

Embodiments of the present disclosure further provides a computer program, comprising: instructions that, when executed by a processor, cause the processor to perform the video processing method of any one of the above embodiments.

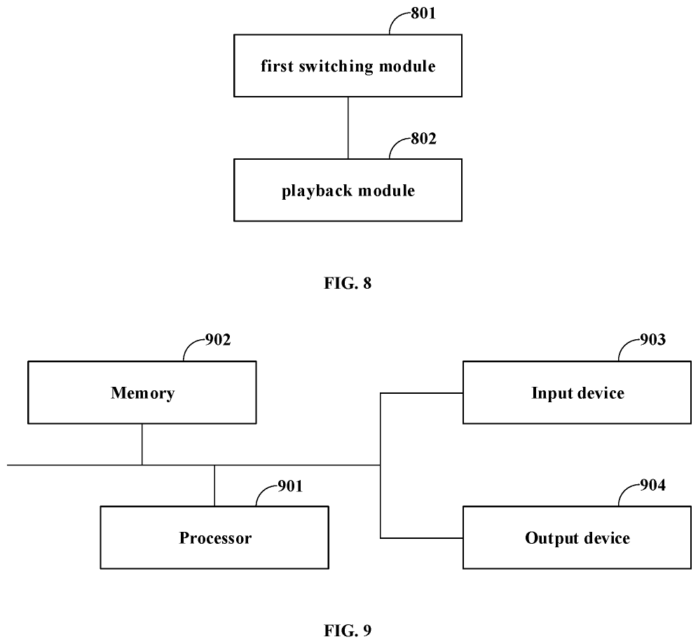

In addition, embodiments of the present disclosure further provide a video processing device. As shown in FIG. 9, the video processing device may comprise: a processor (s) 901, a memory 902, an input device 903, and an output device 904. The video processing device may comprise one or more processors 901. FIG. 9 shows one processor, as an example. In some embodiments of the present disclosure, the processor 901, memory 902, input device 903, and output device 904 may be connected through a bus or other means, wherein FIG. 9 shows a bus connection, as an example.

The memory 920 may be used to store software programs and modules. The processor 901 executes software programs and modules stored in memory 902 to perform various application functions and data processing of the video processing device. The memory 902 may mainly comprise a program storage area and a data storage area, wherein the program storage area may store an operating system, and applications required for at least one function, etc. Moreover, the memory 902 may comprises high speed random access memory, or may comprise non-volatile memory, such as at least one magnetic storage device, a flash memory device or other non-volatile solid-state storage device. The input device 902 can be used to receive figure or character information inputted and generate a signal input related to a user setup or function control of the video processing apparatus.

For examples, in this embodiment, the processor 901 will load executable files corresponding to the processes of one or more applications into the memory 902 in accordance with the following instructions, and the processor 901 will execute the applications stored in the memory 902, thereby implementing the various functions of the video processing device described above.

Note that, in this description, the use of relational terms, if any, such as “first” and “second” and the like are used solely to distinguish one from another entity or action without necessarily requiring or implying any actual such relationship or order between such entities or actions. Further, terms “comprise”, “comprise” or their any other variations are intended to encompass non-exclusive composition, so that a process, method, product or device comprising a series of factors may comprise not only these factors, but also other factors that are not listed explicitly, or factors intrinsic to this process, method, product or device. Without limitation, a factor defined by wording “comprise one . . . ” does not exclude the existence of other same factors in a process, method, product or device comprising such factor.

The above descriptions are only specific embodiments of the present disclosure, so that those skilled in the art can understand or implement the present disclosure. Various modifications to these embodiments will be apparent to those skilled in the art, and the generic principles defined herein may be implemented in other embodiments without departing from the spirit or scope of the present disclosure. Accordingly, the present disclosure should not be limited to the specific embodiments described herein but should be accorded the broadest scope consistent with the principles and novel features disclosed herein.

1. A video processing method, comprising:
switching to a playback page of a preset first video in a video collection corresponding to a video collection entrance, in response to a trigger operation on the video collection entrance, wherein the video collection is a collection of multiple videos comprising the preset first video; and
playing back the preset first video in the playback page.

2. The video processing method according to claim 1, further comprising:
displaying a collection list exhibition entrance to the video collection in a video title area in the playback page, wherein the video title area is used to display video content description information of the preset first video; and
displaying a half-screen window in the playback page, and displaying a list of the video collection in the half-screen window, in response to a trigger operation on the collection list exhibition entrance.

3. The video processing method according to claim 1, further comprising, after the playing back the preset first video:
displaying a list of a video collection to which the preset first video belongs in the playback page, in response to a trigger operation on a collection list exhibition entrance in the playback page of the preset first video; and
switching from the preset first video to any video in the list, in response to a trigger operation on the any video.

4. The video processing method according to claim 1, wherein the video collection entrance is set in a user's homepage, and
the switching to the playback page of the preset first video in the video collection corresponding to the video collection entrance, in response to the trigger operation on the video collection entrance comprises:
switching from the user's homepage to the playback page of the preset first video in the video collection corresponding to the video collection entrance, in response to the trigger operation on the video collection entrance in the user's homepage.

5. The video processing method according to claim 1, further comprising:
switching to a video collection creation page, in response to a trigger operation on a video collection creation entrance;
receiving a video collection title and a selected video identification in the video collection creation page; and
creating a first video collection based on the video collection title and the selected video identification, in response to a trigger operation for a video collection creation.

6. The video processing method according to claim 5, further comprising, after the creating the first video collection:
switching from the video collection creation page to a playback page of a preset second video in the first video collection, in response to the completion of the creation of the first video collection; and
displaying a list of the first video collection in the playback page of the preset second video, while playing back the preset second video in the playback page of the preset second video.

7. The video processing method according to claim 6, further comprising, after the displaying the list of the first video collection in the playback page of the preset second video:
adjusting an order of videos in the list of the first video collection, in response to an order adjustment operation.

8. The video processing method according to claim 6, further comprising, after the displaying the list of the first video collection in the playback page of the preset second video:
deleting any video of the list of the first video collection from the first video collection and the list of the first video collection, in response to a deletion operation on the any video.

9. The video processing method according to claim 1, further comprising:
displaying a window comprising a list of video collections to which a target video is addible, in response to a trigger operation for adding the target video to a video collection; and
adding the target video to a selected video collection, if a selection operation is received on any video collection of the video collections to which the target video is addible.

10. The video processing method according to claim 9, wherein the window comprising the list of video collections to which the target video is addible also comprises a video collection creation entrance, and
after displaying the list of video collections to which the target video is addible, the video processing method further comprises:
switching to a video collection creation page, if a trigger operation is received on the video collection creation entrance placed in the window comprising the list of video collections to which the target video is addible; and
creating a second video collection based on the target video in the video collection creation page.

11. (canceled)

12. A non-transitory computer-readable storage medium storing thereon instructions that, when executed on a terminal device, cause the terminal device to implement a video processing method according to comprising:
switching to a playback page of a preset first video in a video collection corresponding to a video collection entrance, in response to a trigger operation on the video collection entrance, wherein the video collection is a collection of multiple videos comprising the preset first video; and
playing back the preset first video in the playback page.

13. An electronic device, comprising: a processor, a memory, the memory being stored with a computer program which is executable on the processor, wherein the processor, when executing the computer program, implements a video processing method comprising:
switching to a playback page of a preset first video in a video collection corresponding to a video collection entrance, in response to a trigger operation on the video collection entrance, wherein the video collection is a collection of multiple videos comprising the preset first video; and
playing back the preset first video in the playback page.

14. (canceled)

15. (canceled)

16. The electronic device according to claim 13, wherein the processor, when executing the computer program, implements the following steps:
displaying a collection list exhibition entrance to the video collection in a video title area in the playback page, wherein the video title area is used to display video content description information of the preset first video; and
displaying a half-screen window in the playback page, and displaying a list of the video collection in the half-screen window, in response to a trigger operation on the collection list exhibition entrance.

17. The electronic device according to claim 13, wherein the processor, when executing the computer program, implements the following steps:
after the playing back the preset first video, displaying a list of a video collection to which the preset first video belongs in the playback page, in response to a trigger operation on a collection list exhibition entrance in the playback page of the preset first video; and
switching from the preset first video to any video in the list, in response to a trigger operation on the any video.

18. The electronic device according to claim 13, wherein the video collection entrance is set in a user's homepage,
the processor, when executing the computer program, implements the following steps:
the switching to a playback page of a preset first video in a video collection corresponding to a video collection entrance, in response to a trigger operation on the video collection entrance comprises:
switching from the user's homepage to the playback page of the preset first video in the video collection corresponding to the video collection entrance, in response to the trigger operation on the video collection entrance in the user's homepage.

19. The electronic device according to claim 13, wherein the processor, when executing the computer program, implements the following steps:
switching to a video collection creation page, in response to a trigger operation on a video collection creation entrance;
receiving a video collection title and a selected video identification in the video collection creation page; and
creating a first video collection based on the video collection title and the selected video identification, in response to a trigger operation for a video collection creation.

20. The electronic device according to claim 19, wherein the processor, when executing the computer program, implements the following steps:
after the creating the first video collection, switching from the video collection creation page to a playback page of a preset second video in the first video collection, in response to the completion of the creation of the first video collection; and
displaying a list of the first video collection in the playback page of the preset second video, while playing back the preset second video in the playback page of the preset second video.

21. The electronic device according to claim 20, wherein the processor, when executing the computer program, implements the following steps:
after the displaying a list of the first video collection in the playback page of the preset second video, adjusting an order of videos in the list of the first video collection, in response to an order adjustment operation.

22. The electronic device according to claim 20, wherein the processor, when executing the computer program, implements the following steps:
after the displaying a list of the first video collection in the playback page of the preset second video, deleting any video of the list of the first video collection from the first video collection and the list of the first video collection, in response to a deletion operation on the any video.

23. The electronic device according to claim 13, wherein the processor, when executing the computer program, implements the following steps:
displaying a window comprising a list of video collections to which a target video is addible, in response to a trigger operation for adding the target video to a video collection; and
adding the target video to a selected video collection, if a selection operation is received on any video collection of the video collections to which the target video is addible.
